(19) United States
(12) Patent Application Publication
(10) Pub. No.: US 2005/0237689 A1
(43) Pub. Date: Oct. 27, 2005

(54) Method and device for protecting an electronic component

(75) Inventor: Thomas Maier, Regensburg (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 11/110,397

(22) Filed: Apr. 20, 2005

(30) Foreign Application Priority Data
Apr. 26, 2004 (DE) 10 2004 020 274.5

(51) Int. Cl. H02H 5/04

(52) U.S. Cl. 361/103; 327/512

(57) ABSTRACT

A switch-off threshold of an electronic component for protecting from a temperature-specific overload is determined by comparing a parameter directly dependent on the temperature of the electrical component with a parameter indirectly dependent on the temperature of the electrical component. In this way, standard components can be used, power transistors in particular, which are monitored by an external temperature sensor.

### BACKGROUND OF THE INVENTION

1. Field of the Invention

The invention relates to a device and a method for protecting an electronic component, in particular a field effect transistor from temperature-related destruction and/or overload.

Published, European patent application EP 0 323 813 A1 discloses a device for protecting an integrated power circuit from over temperatures. The device contains two sensors integrated in the circuit. In this case, the first sensor supplies an output value dependent on the temperature of the integrated circuit and the second sensor supplies a second output value dependent on the current through the component, in this case a power transistor.

With the known circuit configuration, the current flow through the transistor is set as a function of the output value of the two sensors. In this case, with an increased temperature, the threshold for a reduction of the collector emitter current is reduced in the integrated circuit.

In order to be able to provide a reliable power amplifier, it must be protected from overload damage. In addition, the temperature sensors are integrated into the power amplifier, as mentioned above. One measure for the performance of the protective circuit is the thermal transition between the electronic component and the thermal sensor element. With a bad thermal connection and a fast heating process, which can occur with large currents for example, extremely large temperature differences can exist between the electronic component and the temperature sensor. Therefore, the actual temperature of the electronic component can be considerably higher than that of the sensor element. The result of this is that the electronic component can be damaged or destroyed, because an evaluation circuit linked to the sensor element has not yet determined an over temperature.

With field effect transistors (FET) and metal oxide field effect transistors (MOSFET) the temperature of the barrier of the semiconductor device may amount to no more than 175° C. With bipolar transistors, the maximum admissible barrier temperature is somewhat higher, 200° C. in fact. With the maximum admissible barrier temperature, the residual currents of the semiconductor components can be 100 times greater than at 25° C. The failure probability of the semiconductor device increases with an increasing barrier temperature. Thus, the semiconductor device should be reliably protected from over temperatures. The drain-source current of a transistor is referred to here as the residual current.

In order to achieve reliable protection, the temperature sensors are mainly integrated into the electronic component, disposed directly thereon or disposed as close as possible to the region of the component (in this case the barrier of a power transistor) reacting to the increased temperature. This configuration is nevertheless disadvantageous in that instead of standard components, only components with integrated temperature sensors can be used.

### SUMMARY OF THE INVENTION

It is accordingly an object of the invention to provide a method and a device for protecting an electronic component that overcomes the above-mentioned disadvantages of the prior art methods and devices of this general type, which protects the electronic component as much as possible from a temperature-specific destruction, as a function of the thermal transition between a temperature sensor and the electronic component.

With the foregoing and other objects in view there is provided, in accordance with the invention, a method for protecting an electrical component from a temperature-specific malfunction. The method includes determining a first measurement value being directly dependent on a temperature of the electronic component, determining a second measurement value being indirectly dependent on the temperature of the electronic component, and comparing the first measurement value with the second measurement value. The electronic component is switched on or off, if a result of a comparison exceeds or undershoots a predetermined threshold.

In this case, a first measurement value is compared to a second measurement value. If the result of the comparison exceeds or falls short of a predetermined threshold value, the electrical component is switched off or on. In this way, the first measurement value is directly dependent on the temperature of the electrical component and the second measurement value is indirectly dependent on the temperature of the electrical component.

Furthermore, the electrical component providing the second measurement value that is indirectly dependent on the temperature of the component is not integrated in the electrical component to be examined. This allows standard components that do not have integrated protective circuits to be used. The configuration of a circuit of this type results among other things in a considerable cost-savings.

In a preferred embodiment of the invention, the first and the second average value are compared by subtraction.

In this way in a particularly simple manner, exceeding or not reaching the predetermined threshold value can be established by a change of sign in the result of the subtraction.

In a further preferred exemplary embodiment, the method and/or the device has a further switch-off threshold that depends exclusively on one of the two measurement values.

Furthermore, a second measurement value can be compared to the first measurement values of a number of electrical components.

This produces particular advantages in terms of the construction space required and the number of electronic components required since an additional external temperature sensor can be used for a number of electronic components.

Other features which are considered as characteristic for the invention are set forth in the appended claims.

Although the invention is illustrated and described herein as embodied in a method and a device for protecting an electronic component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a circuit diagram of a first exemplary embodiment of a circuit configuration according to the invention;

FIG. 2 is a circuit diagram of a second exemplary embodiment of the circuit configuration according to the invention; and

FIG. 3 is a graph of a first and a second measurement value over time.

### DESCRIPTION OF THE PREFERRED EMBODIMENTS

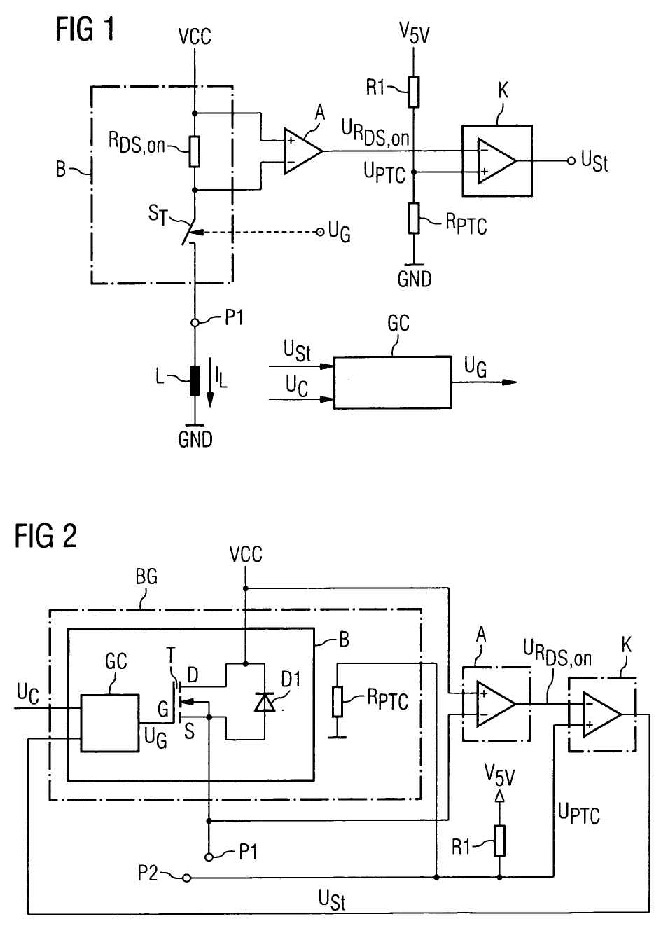

Referring now to the figures of the drawing in detail and first, particularly, to FIG. 1 thereof, there is shown an electronic component B, which serves to switch an electronic load L on or off. A series circuit containing the electronic component B and the load L is disposed between a first potential VCC and a second potential GND of an operating voltage source. A link point between the component B and the load L has been indicated here by reference character P₁.

The electronic component B is shown here schematically with a resistor R_{DS,on} and a circuit ST, as an equivalent circuit diagram. The resistor R_{DS,on} and the switch ST are connected in series.

Component B can be a circuit breaker, a FET, MOSFET or IGBT for example. This can also be a part of a half bridge configuration to control a load L, such as a gearbox in a motor vehicle for example.

The switch ST is switched on or off by a voltage U_{G}. The voltage U_{G} is made available by a control circuit GC (Gate Control), as a function of two input parameters. The control voltage U_{G} is generated by the control circuit GC as a function of an on/of f switching signal U_{C} and the output voltage U_{ST} of a comparator K. The output voltage U_{ST} of the comparator K supplies the control circuit GC, with a switch-on or switch-off signal for the circuit S_{T}, as a function of the temperature of the component. The control signal U_{ST} can be linked to the switch-on/switch-off signal U_{C} for example, by an AND gate. The circuit S_{T} is then only switched on if both voltages U_{ST} and U_{C} have a level such that should result in the circuit being turned on, according to the predefined threshold values.

In order to ensure a prompt switch-off of the electrical component B with a temperature T that is no longer tolerable, temperature sensors are disposed outside the component, in this case a PTC resistor R_{PTC}. The comparator K determines on the one hand the electrical current U_{PTC} dropping over the PTC resistor R_{PTC}, and on the other hand an electrical current U_{RDS,on} dropping over the resistor R_{DS,on}. The resistor R_{DS,on} represents a temperature-dependent parameter of the component B, in this case the resistance between drain and source of the field effect transistor. This is recorded using a differential amplifier A, and fed to the comparator K on its inverted input (−). The load current I_{L} is assumed here either as constant or determined via a measurement resistor, thereby taking account of a possible change in the load current I_{L} during the evaluation of the measurement result.

On the one hand, the PTC resistor is linked to a third potential V_{SV} via a resistor R₁, in this case 5V, and on the other hand to a second potential GND of the supply voltage source. The voltage U_{PTC} dropping via the PTC resistor is supplied to the comparator K at its noninverting input (+). The control voltage U_{St} is determined here by a comparison, in this case a subtraction of two voltages U_{RDS,on} and U_{PTC}. The first measurement value, the voltage U_{RDS,on} is thus directly dependent on the temperature of the electrical component B. As the resistor R_{PTC} is disposed in a thermal coupling to the component B, the second measurement value, the voltage U_{PTC} is indirectly dependent on the temperature of the electrical component B. The quality of the thermal coupling between the component B and the PTC resistor depends on its spacial arrangement in relation to the component B.

The circuit configuration is useful in that, as a result of the indirect or direct coupling, the two temperature-dependent voltages U_{RDS,on} and U_{PTC} drift apart at the source of the temperature change, due to the different thermal time instants of the coupling, in other words, the rate of increase of the two voltages U_{RDS,on} und U_{PTC} are different.

In the present case, the switch-off threshold is selected such that the electrical component B is switched off, once the voltage U_{ST} at the output of the comparator K is approximately equal to 0. In this case, the voltage U_{RDS,on} would be equal to the voltage U_{PTC} dropping via the PTC resistor.

In addition to subtracting two of the voltages U_{RDS,on} and U_{PTC} dependent on the temperature of the electrical components B, other operations are also possible, such as an addition, a multiplication, or also a division of these two input parameters U_{RDS,on} und U_{PTC} for example. The switch-off threshold, here U_{ST} approximately equal to 0 volts, is selected such that the temperature of the electrical component B for the switch-off threshold exceeds a predetermined temperature of 120° C. for example.

As a result of comparing or linking the directly temperature-dependent voltage U_{RDS,on} and the indirectly temperature-dependent voltage U_{PTC}, the excess current switch-off threshold is achieved and the power amplifier is switched off in an overload case, by rapidly heating the component B even with lower temperatures. The excess current switch-off threshold is dependent on the current difference between the voltage U_{RDS,on} and the voltage U_{PTC}. In this way, the loading of the electrical component B is reduced and thus guards against the failure of the component.

FIG. 2 shows a further exemplary embodiment of a device for protecting an electronic component. In this diagram, functionally identical components are given the same reference characters as in FIG. 1.

The electrical component B is shown again here, in this case an integrated circuit containing an N channel MOSFET T and a control circuit GC. Diode D1 is disposed parallel to the drain source stretch of transistor T. The diode D1 is a substrate diode present in any event on a MOSFET.

The MOSFET T is electrically connected with its drain connection D to the first potential VCC of the supply voltage source and with its source connection S to a node P₁. The node P₁ is electrically connected to the second potential GND of the supply voltage source via the load L, as shown in FIG. 1. A PTC resistor R_{PTC} is also disposed here spacially separated from the integrated electronic component B. The electronic component B and the PTC resistor R_{PTC} are combined here into one component assembly BG. This combination is intended to clarify the spacial proximity of the component B and the PTC resistor R_{PTC}.

On the one hand, the PTC resistor R_{PTC} is connected to a resistor R₁ and on the other hand to the second potential GND of the voltage supply. The second connection of the resistor R₁ is connected to a third potential V_{5V}. The resistors R_{PTC} and R₁ form a voltage divider, the voltage U_{PTC} fed to the comparator K being varied as a function of the value of the PTC resistor R_{PTC}.

The control circuit GC also has an input for a switch-on/switch-off signal U_{C} and the output voltage U_{ST} of the comparator.

In a similar manner to the exemplary embodiment according to FIG. 1, the voltage U_{RDS,on} dropping over the drain source route of the transistor T is determined by a difference amplifier A and fed to the inverting input (−) of the comparator K. On the one hand, the voltage dropping over the PTC resistor R_{PTC} is fed to the noninverting (+) input of the comparator K, on the other hand, it can be fed to a non-illustrated further circuit configuration by a node P₂. By way of example, this can contain a microcontroller with an analog-digital converter. If a predetermined threshold value U_{PTC,max} is exceeded, the electronic component B can also only be switched off as a function of the voltage U_{PTC} dropping over the PTC resistor. This prevents an absolute maximum temperature, Tₘₐₓ=130° C. being exceeded for example.

The resistor U_{RDS,on} has a positive temperature coefficient. This fluctuates in a region between 0.7% K⁼¹≦α≦1.8% K⁻¹. The positive temperature coefficicent a increases the loss performance of the MOSFET T operating as a circuit and can, in extreme cases, result in a malfunction of the transistor T.

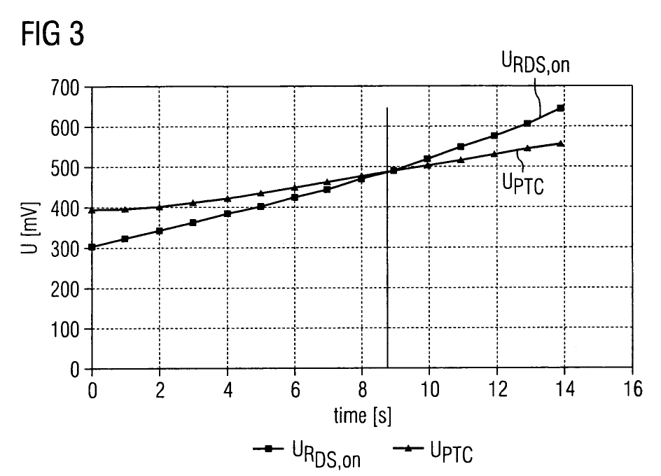

FIG. 3 shows the graph of the first and the second measurement value, voltages U_{RDS,on} and U_{PTC} as a function of time. As illustrated in this diagram, the voltage U_{RDS,on} has a larger increase than the voltage U_{PTC}. This results in U_{PTC}<U_{RDS,on} for t=0, in that the two curves intersect each other after approximately nine seconds. In both exemplary embodiments according to FIGS. 1 and 2, this intersection point results in an output voltage U_{ST of} 0 volts at the comparator K. In this case, the electronic component B would be switched-off.

The first measurement value U_{RDS,on} is directly dependent on the temperature of the component B, in other words, the measurement value is directly tapped at the location of the temperature change. The second measurement value U_{PTC} changes as a direct consequence of the thermal coupling by the heat derived from the component B. The second measurement value U_{PTC} is measured physically distanced from the component B and is determined based on the measurement value of the temperature of the component B.

This application claims the priority, under 35 U.S.C. § 119, of German patent application No. 10 2004 020 274.5, filed Apr. 26, 2004; the entire disclosure of the prior application is herewith incorporated by reference.

1. A method for protecting an electrical component from a temperature-specific malfunction, which comprises the steps of:
determining a first measurement value being directly dependent on a temperature of the electronic component;
determining a second measurement value being indirectly dependent on the temperature of the electronic component;
comparing the first measurement value with the second measurement value; and
switching on or off of the electronic component, if a result of a comparison exceeds or undershoots a predetermined threshold.

2. The method according to claim 1, which further comprises performing the comparison between the first measurement value and the second measurement value by subtraction.

3. The method according to claim 1, which further comprises switching off the electronic component if the first measurement value is approximately equal to the second measurement value (U_{PTC}).

4. The method according to claim 1, which further comprises:
comparing the second measurement value with a predetermined threshold value; and
generating a control signal for switching off the electronic component in dependence on a result of the comparison.

5. The method according to claim 1, which further comprises providing a power transistor as the electronic component.

6. A device for protecting against a temperature-specific malfunction, comprising:
an electronic component;
a comparator receiving a first measurement value being directly dependent on a temperature of said electronic component and a second measurement value indirectly dependent on the temperature of said electronic component, said comparator outputting an output signal; and
a control circuit coupled to and switching said electronic component on or off in dependence on the output signal received from said comparator.

7. The device according to claim 6, wherein said electronic component is one of at least two electronic components, whereby each of said two electronic components takes the first measurement value directly dependent on the temperature of said respective electronic component, the two first measurement values and the second measurement value are fed to said comparator, said comparator comparing each of the first measurement values with the second measurement value, and said control circuit switches said respective electronic component on or off, if a result of an associated comparison exceeds or undershoots a predetermined threshold.

8. The device according to claim 6, wherein said electronic component is a power transistor.
